(19) United States
(12) Patent Application Publication
(10) Pub. No.: US 2015/0375635 A1
(43) Pub. Date: Dec. 31, 2015

(54) CONTROL DEVICE FOR VEHICLE

(71) Applicant: TOYOTA JIDOSHA KABUSHIKI KAISHA, Toyota-shi (JP)

(72) Inventor: Toshiya HASHIMOTO, Miyoshi-shi (JP)

(73) Assignee: TOYOTA JIDOSHA KABUSHIKI KAISHA, Toyota-shi (JP)

(21) Appl. No.: 14/747,113

(22) Filed: Jun. 23, 2015

(30) Foreign Application Priority Data
Jun. 25, 2014 (JP) 2014-129888

(51) Int. Cl. B60L 11/18

(52) U.S. Cl. CPC B60L 11/1861; B60L 11/1868

(57) ABSTRACT

SOC of an electrical power source made consistent with a traveling state. An electrical power source system is provided with a plurality of electrical power sources, and drives a motor generator. At the time of traveling, electrical power exchange for a plurality of electrical power sources is controlled by a converter based on temperature of the electrical power sources and travel information or route information, and SOC of one electrical power source, among the plurality of electrical power sources, is controlled to a specified value.

### PRIORITY INFORMATION

This application claims priority to Japanese Patent Application No. 2014-129888, filed on Jun. 25, 2014, which is incorporated herein by reference in its entirety.

### BACKGROUND OF THE INVENTION

1. Technical Field

The present invention relates to a control device for a vehicle, provided with an electrical power system having a plurality of electrical power sources, for driving a motor using electrical power from the power supply system.

2. Background Art

With an electric vehicle such as a hybrid vehicle or an electric car, a system is often used where dc power of a battery is converted to ac power by an inverter, and a motor or motor generator is driven by the converted ac power. Also, battery voltage is often supplied to a motor after being boosted using a boost converter (voltage converter).

Patent literature 1 shows a system provided with two sets of a battery and a boost converter, for supplying power after boosting using output of the two converters. With this type of system, by independently controlling two boost converters it is made possible to deal with a wide range of situations.

Also, in patent literature 2, there is proposed a system for carrying out series-parallel switching of a plurality of batteries at a low voltage side, by variously changing on/off operating patterns of four switching elements of a boost converter. With this type of system, it is possible to significantly change a voltage at a low voltage side, and it is possible to significantly change the output voltage at the low voltage side.

Patent literature 3 shows a plurality of batteries, and that magnitude of charge-discharge power for individual batteries is adjusted based on battery temperature. Also, patent literature 4 shows a plurality of batteries, and shows that magnitude of battery charge-discharge power is changed in accordance with traveling mode of the vehicle (EV priority mode where priority is given to traveling as an electric vehicle, or HV priority mode where priority is given to traveling as a hybrid vehicle).

### CITATION LIST

### Patent Literature

Patent literature 1: Japanese patent laid-open No. 2011-97693

Patent literature 2: Japanese patent laid-open No. 2012-70514

Patent literature 3: Japanese patent laid-open No. 2008-278561

Patent literature 4: International Patent No. WO2011/125184

### SUMMARY OF THE INVENTION

### Technical Problem

With patent publications 1 to 4, using a plurality of batteries within the system, voltage at a high voltage side is changed significantly after boosting, and charge-discharge of the plurality of batteries is individually controlled.

On the other hand, charge-discharge capability of a battery varies depending on temperature of the environment the vehicle is traveling in etc. With the system having a plurality of batteries (electrical power sources), by carrying out state-control of appropriate electrical power sources in accordance with the vehicle environment, it is possible to achieve a more efficient operation of the vehicle.

### Means for Solving the Problems

The present invention is a control device for a hybrid vehicle that is provided with an engine, a motor, and a plurality of electrical power sources for supplying electrical power to the motor, wherein SOC of one electrical power source, among the plurality of electrical power sources, is controlled to a specified value based on temperature of the plurality of electrical power sources, and at least either travel state of the vehicle or travel route information.

With one embodiment, when the plurality of electrical power sources are in a low temperature state, SOC is controlled so that a difference between size of permissible discharge amount and size of permissible charge amount of one electrical power source, among the plurality of electrical power sources, becomes minimum.

With another embodiment, when the plurality of electrical power sources are in a low temperature state, SOC of one electrical power source, among the plurality of electrical power sources is controlled so that permissible discharge amount of the one electrical power source becomes maximum.

With a further embodiment, when the plurality of electrical power sources are in a low temperature state, in a case where a regenerative braking state is maintained, SOC of one electrical power source, among the plurality of electrical power sources, is controlled so that permissible charge amount of the one electrical power source becomes maximum.

### Advantage of the Invention

According to the present invention, it is possible set SOC of one electrical power source, among two electrical power sources, to SOC consistent with a traveling state at that time, and appropriate motor drive is possible.

### BRIEF DESCRIPTION OF THE DRAWINGS

FIG. 1 is a drawing showing system structure including a control device for a vehicle of an embodiment.

FIG. 2 is a flowchart showing one example of SOC control.

FIG. 3 is a drawing showing a relationship between SOC and permissible charge-discharge amount.

FIG. 4 is a drawing showing a relationship between SOC, permissible charge-discharge amount and temperature.

FIG. 5 is a flowchart showing another example of SOC control.

FIG. 6 is a flowchart showing a further example of SOC control.

FIG. 7 is a flowchart showing a still further example of SOC control.

FIG. 8 is a flowchart showing yet a further example of SOC control.

FIG. 9 is a drawing showing a relationship between SOC and permissible charge-discharge amount.

FIG. 10 is a flowchart showing yet another example of SOC control.

FIG. 11 is a flowchart showing another example of SOC control.

FIG. 12 is a flowchart showing another example of SOC control.

FIG. 13 is a flowchart showing another example of SOC control.

FIG. 14 is a flowchart showing another example of SOC control.

FIG. 15 is a drawing showing a relationship between SOC and permissible charge-discharge amount.

FIG. 16 is a flowchart showing yet another example of SOC control.

FIG. 17 is a drawing showing another structural example of a system including a control device for a vehicle.

### DETAILED DESCRIPTION OF THE EMBODIMENTS

Embodiments of the present invention will be described in the following based on the drawings. The present invention is not limited by the embodiments described herein.

### Vehicle System Structure

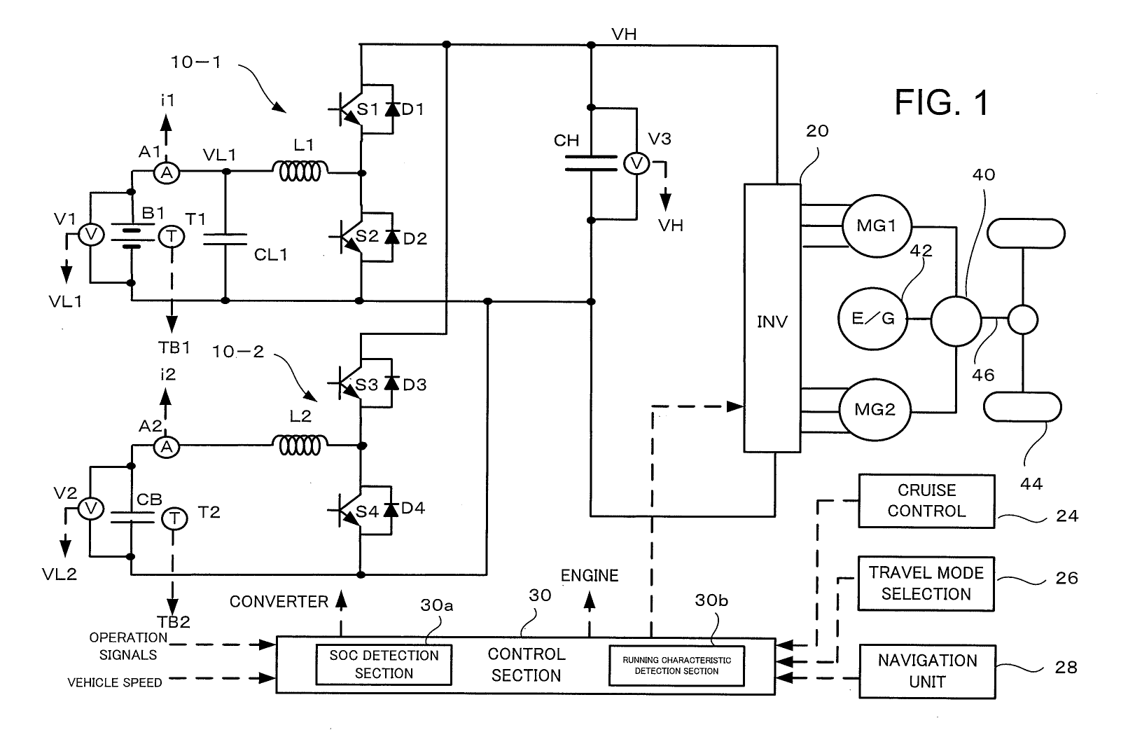

FIG. 1 shows a system structure including a control device for a vehicle relating to the embodiment. Two dc power sources are provided, namely a battery B1 and a capacitor CB. The battery B1 and capacitor CB are respectively connected to converters 10-1 and 10-2, which are electrical power converters. The converters 10-1 and 10-2 respectively boost dc voltages VL1 and VL2 from the battery B1 and capacitor CB at the low-tension side, and output high voltage side voltage VH that has been boosted from common positive and negative output terminals at the high voltage side. With this embodiment, the capacitor CB is a small capacity output type electrical power source having a maximum input-output power that is larger than the battery B1, while the battery B1 is an electrical power source of small maximum input-output power having greater capacity than the capacitor CB.

The positive and negative output terminals of the converters 10-1 and 10-2 are connected to the inverter 20 using respective positive lines and negative lines. A high voltage side condenser CH is arranged on the positive and negative lines at the input side of the inverter 20, and input voltage of the inverter 20 is smoothed.

The inverter 20 is made up of two three-phase inverters provided in parallel, with motor generators MG1 and MG2 being respectively connected as motors to the two inverters. Accordingly, by performing respective ON OFF control of switching elements of the two inverters of the inverter 20, specified three-phase current is supplied to the motor generators MG1 and MG2 and the motor generators MG1 and MG2 are driven.

A control section 30 is also provided, with this control section 30 performing ON OFF control of the converters 10-1 and 10-2 and the switching elements of the inverter 20, and controlling power conversion by the converters 10-1 and 1-2 as well as drive of the motor generators MG1 and MG2 by the inverter 20.

Output shafts of the motor generators MG1 and MG2 are connected to a power distributor 40 constituted by, for example, a planetary gear train. A drive shaft 46 for transmitting power to an output shaft 42 of an engine (E/G) and vehicle wheels 44 is also connected to this power distributor 40, and various power transmission is carried out using this power distributor 40. For example, the drive shaft 46 is driven by output of the engine 42, power is generated by driving the motor generator MG2 using output of the engine 42, vehicle wheels 44 are driven by output of the motor generator MG2, and regenerative braking is carried out utilizing the motor generator MG2. It is also possible to output drive force using the motor generator MG1, and carry out regenerative braking using the motor generator MG2.

The converter 10-1 of this embodiment has two switching elements S1 and S2 connected in series. These switching elements S1 and S2 are formed from power elements such as IGBT, and are connected in series with collectors at an upper side. The collector of the upper switching element S1 is connected to a positive line of the high voltage side, the emitter of the switching element S1 is connected to the collector of switching element S2, and the emitter of the lower switching element S2 is connected to a negative line of the high voltage side. The negative line is connected to earth.

Also, diodes D1 and D2 in which current flows in a direction from emitter to collector are respectively connected in parallel with each switching element S1, S2, and current of an inverse direction flows in the switching elements S1 and S2.

The converter 10-2 has the same structure as the converter 10-1, and has two switching elements S3 and S4 connected in series. The collector of the upper switching element S3 is connected to a positive line of the high voltage side, while the emitter of the lower switching element S4 is connected to a negative line of the high voltage side. Also, diodes D3 and D4 in which current flows in a direction from emitter to collector are respectively connected in parallel with each switching element S3, S4, and current of an inverse direction flows in the switching elements S3 and S4.

Voltage sensors V1 and V2 are connected to both ends of the battery B1 and capacitor CB, to detect voltages VL1 and VL2 of the battery B1 and the capacitor CB. Also, a voltage sensor V3 is connected to both ends of the condenser CH to detect a high voltage side voltage VH. Charge-discharge current of the battery B1 and the capacitor CB is detected by current sensors A1 and A2. Further, temperature sensors T1 and T2 for measuring battery temperature are provided in the battery B1 and the capacitor CB, to detect temperatures TB1 and TB2 of the battery B1 and the capacitor CB. Instead of the capacitor CB, a battery B2 can also be used, and in this case it is preferable for a condenser CL2 to be arranged in parallel with the battery B2. Similarly to the capacitor CB, the battery B2 is an electrical power source having a larger maximum input output power than the battery B1, and small capacity. At the time of low temperature, in this embodiment one of the two electrical power sources (the battery B1 and the capacitor CB) is mainly used (for example, the capacitor CB). Accordingly, it is also possible to only provide a temperature sensor on the electrical power source that will be used, and detect the temperature of that electrical power source.

Further, a cruise control section 24, travel mode selection section 26, navigation unit 28 etc. are provided in the vehicle, and information from these devices is also supplied to the control section 30. The cruise control section 24 is for turning a cruise control on or off in accordance with operation by the driver, and if the cruise control is on the control section 30 maintains the vehicle speed at a set vehicle speed. For example, if the cruise control is turned on while traveling on an expressway at the vehicle speed of 80 km/h, the control section 30 carries out acceleration and deceleration control so as to basically keep the vehicle speed at 80 km/h. If the cruise control is turned on, power consumption becomes small compared to when traveling under the driver's operation. The travel mode selection section 26 is for the driver to set a travel mode, and it is possible to set, for example, HV mode, EV mode, eco-mode, power mode etc. HV mode is a mode for traveling by driving the engine 42 as required, EV mode is a mode for basically traveling without driving the engine 42, eco-mode is a travel mode that is set in order to make output torque small and acceleration and deceleration for accelerator operation are comparatively small, while power mode is a travel mode that is set in order to make output torque large, and acceleration and deceleration for accelerator operation are comparatively large. Power consumption is larger in HV mode compared to EV mode, and power consumption is larger in power mode than in eco-mode.

The navigation unit 28 has a map information storage section and a current location detection means, such as GPS, and displays a map on the display, and displays current position of the vehicle on that map. The navigation unit 28 also has a route search function for a route from a departure point, such as the current position, to a target point that has been input, and with travel where a destination has been set, route guidance to the destination is carried out using voice and display. The map information also includes altitude etc. In the case of traveling where a route to the destination has been set, the route is supplied to the control section 30. Various information for navigation may be also be received from an external information center by means of communication.

Voltages VL1, VL2 and VH that have been detected by the previously described voltage sensors V1, V2 and V3, temperatures TB1 and TB2 that have been detected by the temperature sensors T1 and T2, and battery charge-discharge currents i1 and i2 that have been detected by the current sensors A1 and A2 are supplied to the control section 30, as well as operation signals for accelerator and brake etc. and various signals such as vehicle speed. Based on the various signals that are supplied, the control section 30 carries out on-off control of the switching elements of the converter 10, on off control of switching elements of the inverter 20, and drive control of the engine 42, and controls travel of the vehicle etc. For example, a torque command is generated in accordance with accelerator and brake operation, and switching elements of the inverter 20 and the converter 10 are controlled in accordance with this torque command.

Here, the control section 30 has a SOC detection section 30a, and in this SOC detection section 30a SOC (state of charge) of the battery B1 and the capacitor CB are detected from detected voltages VL1 and VL2 of the voltage sensors V1 and V2, and the battery charge-discharge currents i1 and i2 that have been detected by the current sensors A1 and A2. Various known detection methods may be adopted for detection of the battery SOC.

The control section 30 also has a running characteristic detection section 30b, and the information for travel mode, such as HV mode, EV mode, eco-mode, power mode etc., from the vehicle travel mode selection section 26, travel state of the vehicle such as on-off information for cruise control from the cruise control section 24, and travel route information from the navigation unit 28, are supplied to this running characteristic detection section 30b. The running characteristic detection section 30b maintains power consumption from this point onwards from the supplied vehicle travel state information and travel route information. For example, power consumption amount for travel from this point onwards is estimated from traveling distance, difference in elevation (slope), travel mode and on-off state of cruise control etc. of a route to be traveled from this point onwards, based on the route information.

The control section 30 also determines whether or not the battery B1 and the capacitor CB are in a low temperature state from supplied electrical power source temperatures TB1 and TB2. The charge and discharge permissible power of the battery B1 and the capacitor CB is reduced in a low temperature state. The control section 30 controls SOC of the electrical power sources based on this type of electrical power source state information and power consumption prediction etc.

### Processing at the Time of Low Temperature

In cold areas etc., there may be situations where the temperature of an electrical power source such as the battery B1 or the capacitor CB is low. Particular at the time of starting a vehicle, there may be situations where temperature is extremely low. If the electrical power source temperature is low the performance of the electrical power source is low, and a warm-up operation becomes necessary.

With this embodiment there are a plurality of electrical power sources, and together with facilitating warming up by increasing the chance of exchanging electrical power between the plurality of electrical power sources, the SOC of one of the electrical power sources is controlled to be suitable for travel. In particular, with this embodiment there is the capacitor CB, which is an output type electrical power source, and basically as well as traveling using charge-discharge of the capacitor CB, electrical charge is transferred from the battery B1 so that the SOC of the capacitor CB reaches a target value. Specifically, output of drive power using the motor generator MG1 and motor generator MG2, and electrical power recovery due to regenerative braking, are basically carried out by charging and discharging the capacitor CB, and in the event that the SOC deviates from a target value electric charge is conveyed from the battery S1 to make the SOC of the capacitor CB approach the target value. This processing is processing at the time of low temperature, and if warming up of the capacitor CB and/or the battery B1 is completed normal running is restored. In a case where the engine 42 is driven to generate electricity, the generated electrical power may be charged to any electrical power source from SOC etc. of two electrical power sources at that time, and accordingly it is also possible to drive the vehicle using electrical power from a battery B1 or charge the battery B1 using regenerated power. Since this processing can be carried out when the capacitor CB is at a low temperature, only the temperature of the capacitor CB is measured, and the processing may be carried out in accordance with the temperature of the capacitor CB.

### At the Time of Low Temperature and Moderate Power Consumption

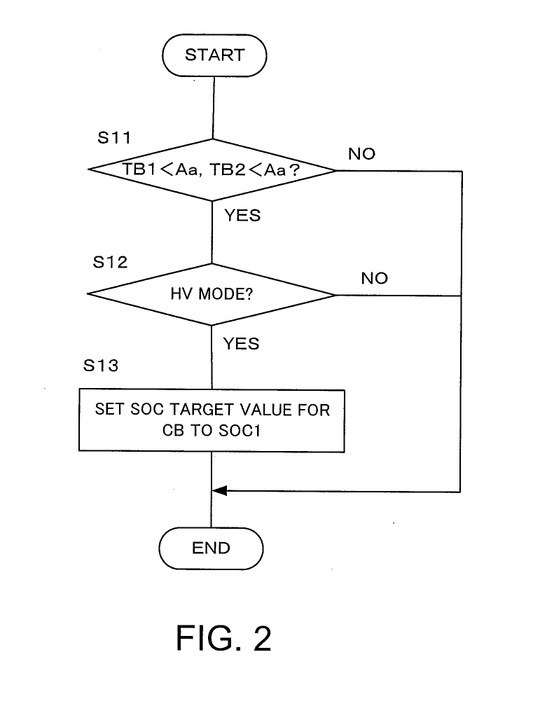

FIG. 2 is a flowchart for control at the time of low temperature, when power consumption from this point onwards is moderate. With this example, consideration is given to whether it is low temperature and whether the travel mode within vehicle traveling state information is HV mode. First, it is determined whether or not electrical power source temperatures TB1 and TB2 are less than equal to Aa, specifically, whether it is low temperature (S11). Aa is, for example, about −15° C. Also, there is normally not a very large difference between the temperatures TB1 and TB2 of the two electrical power sources. It is therefore possible to determine YES if only one of the temperatures is less than or equal to Aa, or to determine YES if both of the temperatures are less than or equal to Aa.

If the determination in S11 is NO, processing is completed. On the other hand, if the determination in S11 is YES, it is determined whether or not it is HV mode (S12). If this determination is NO, processing is terminated, while if the determination is YES, a SOC target value of one electrical power sources, among the two dc electrical power sources, is set to SOC1 (S13). Here, in the case where one of the dc electrical power sources is the battery B1 being a capacity type electrical power source, and the other is the capacitor CB which is an output type electrical power source, as in the structure of FIG. 1, the capacitor CB is selected and the SOC of the capacitor CB is controlled.

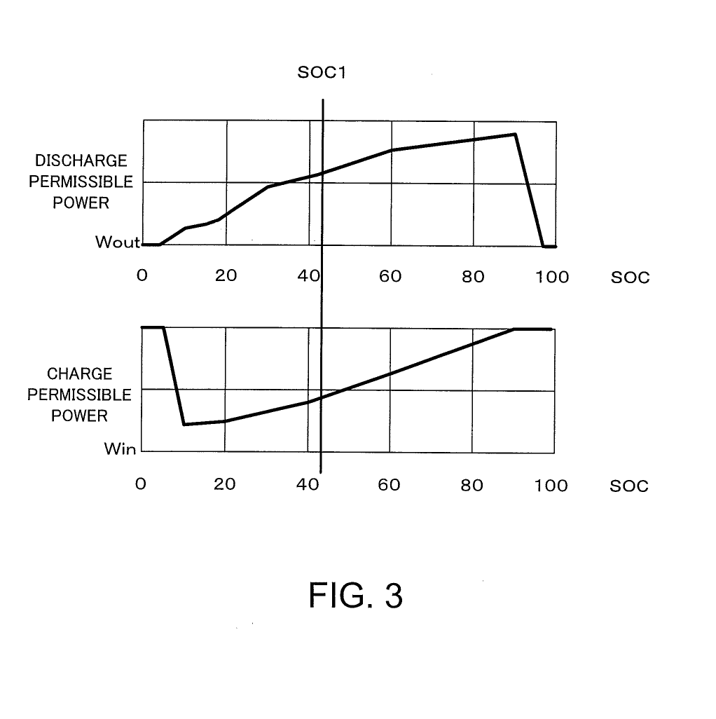

A relationship between SOC, discharge permissible power Wout and charge permissible power Win for an electrical power source is shown in FIG. 3. In this way, there is a value of SOC1 where discharge permissible power and charge permissible power are equal (Wout=Win), for example with the capacitor CB of this embodiment about 43%. The value of SOC1 fluctuates depending on capacity and type etc. of the capacitor CB but is a value of about 50% or slightly smaller than 50%. In this way, by maintaining SOC of the electrical power source such that Wout=Win, it is possible to sufficiently carry out charge and discharge in travel using this electrical power source, and together with carrying out EV travel it is also possible to sufficiently receive regenerated power.

For example, it is preferable to make SOC of the capacitor CB SOC1 by conveying power of the capacitor CB to the battery B1 in a case where SOC of the capacitor CB is higher than SOC1, while conversely conveying power of the battery B1 to the capacitor CB when SOC of the capacitor CB is lower than SOC1. Normally, travel uses power from the capacitor CB, regenerated power is charged to capacitor CB, and charge is conveyed from the battery B1 so that SOC of the capacitor CB becomes a target value.

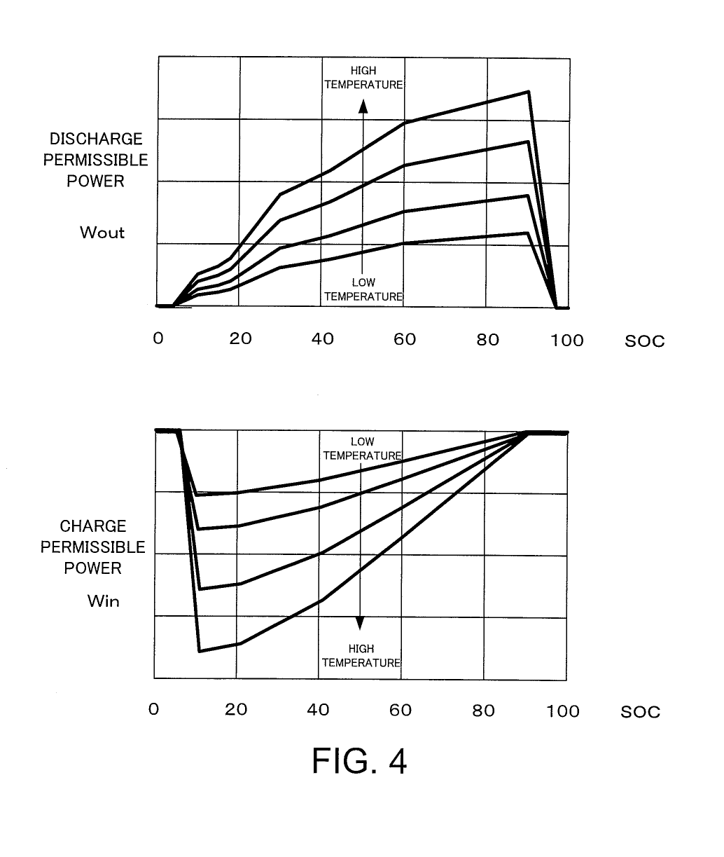

In this way, by carrying out exchange of power between two electrical power sources, the amount of power going into and coming out of each electrical power source is increased, and it is possible to facilitate warming up of the two electrical power sources. A relationship between SOC and charge and discharge permissible power in a case where electrical power source temperature changes is shown in FIG. 4. In this way if warming up of the electrical power source is possible charge and discharge permissible power increase in accordance with temperature.

If it is possible to provide sufficient charge-discharge permissible power it is also possible to stop the engine 42. Specifically, at the time of low temperature, the charge and discharge permissible power of the battery B1 and the capacitor CB are not sufficient, and in HV mode, basically the engine 42 is driven and travel is carried out using that drive power, and warming up of the battery B1 and the capacitor CB does not progress, but with this embodiment warming up can be facilitated. If the temperature of the capacitor CB is raised, the charge and discharge permissible power of the capacitor CB becomes large, and it is possible to have running in normal HV mode where the engine 42 is intermittently driven as required. With this embodiment, in the case where HV mode is stopped also, normal drive takes place, but in the case of low temperature it is preferable to carry out processing to set another target SOC, as will be described later.

As a result, at the time of a specified low temperature, in the event that travel mode while traveling is HV mode, by carrying out power distribution with the SOC of the capacitor CB maintained such that charge and discharge allowable power are identical, it is possible to make both charge and discharge permissible power Win and Wout of the capacitor CB large as well as facilitating a rise in temperature, thereby enabling travel in the HV mode using intermittent engine drive.

Also, with this embodiment, there are the battery B1 and the capacitor CB as two electrical power sources, and in this case an electrical power source having SOC set to SOC 1 is the capacitor CB. This is because with the capacitor CB, which is an output type electrical power source, compared to the battery B1, which is a capacity type electrical power source, voltage fluctuation due to charge-discharge is smaller and it is easy for temperature to rise due to charge-discharge and not simply with exchange of charge.

In a situation where two electrical power sources are batteries B1 and B2, both being capacity type electrical power sources, it is preferable to make SOC of a battery with smaller energy variation, in order to make discharge permissible power and charge permissible power become the same (Wout=Win), as SOC1 where Wout=Win.

Also, in a case where SOC of the capacitor CB is higher than SOC1, it is preferable to make output power distribution ratio of the capacitor CB (proportion of total output power that is output power of the capacitor CB) high, while making output power distribution ratio of the battery B1 (proportion of total output power that is output power of the battery B1) low to make output electrical power of the capacitor CB larger than output electrical power of the battery B1, and to make input electrical power (regenerated power) ratio to the capacitor CB (proportion of total input power (regenerated power) that is input electrical power to the capacitor CB that is output power of the capacitor CB) low while making input electrical power (regenerated power) ratio to the battery B1 (proportion of total input power (regenerated power) that is input electrical power to the battery B1 that is output power of the capacitor CB) high to make input electrical power to the capacitor CB smaller than input electrical power to the battery B1, to thereby reduce the SOC of the capacitor CB, as well as increase the SOC of the battery B1.

### Other Examples

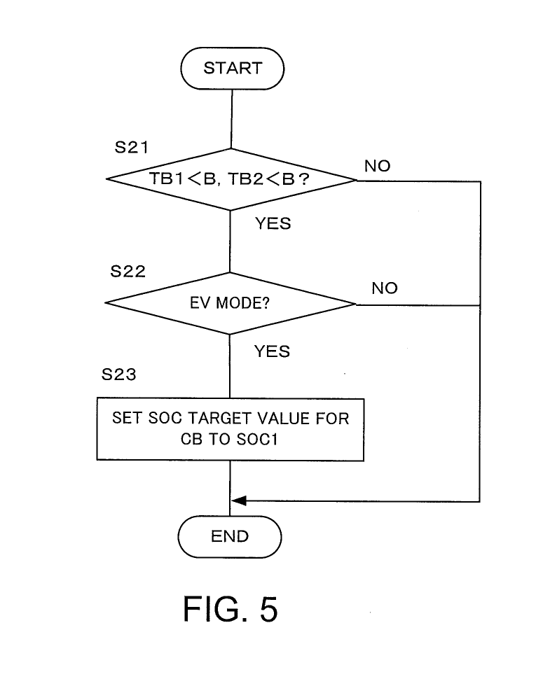

FIG. 5 shows another example where, at the time of low temperature, if a travel mode during a traveling state is EV mode, power distribution is carried out by setting a target value for SOC of the capacitor CB such that charge and discharge permissible power become the same. First, it is determined whether or not electrical power source temperatures TB1 and TB2 are less than equal to B (S21). B is, for example about −20° C., and a lower temperature than Aa. Determination may be YES in a case where only one of the temperatures TB1 and TB2 of the two electrical power sources are less than or equal to B, or maybe YES when both temperatures are less than or equal to B.

If the determination in S21 is NO, processing terminates at that point, while in the event that determination in S21 is YES, it is determined whether or not it is EV mode (S22). If this determination is NO, processing is terminated, while if the determination is YES, a SOC target value of the capacitor CB, which is one electrical power source of the two dc electrical power sources, is set to SOC1 (for example, about 43%) (S23). In the case of EV mode, since the engine 42 is basically not driven, input output power to the electrical power source is large, but in the case of low temperature, it is possible to facilitate warming up by controlling SOC of the capacitor CB.

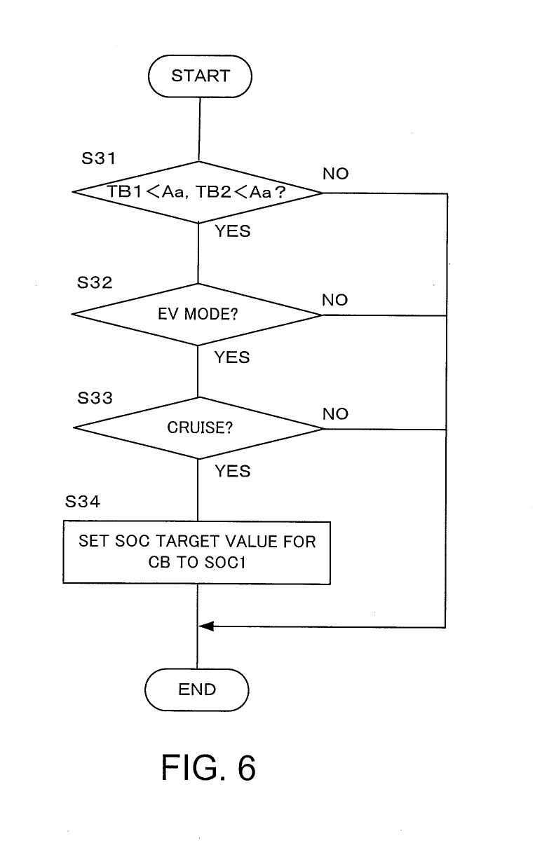

Yet another example is shown in FIG. 6. With this example, besides whether it is low-temperature, it is also considered whether the travel mode while in a traveling state of the vehicle is EV mode, and whether cruise control is on while in a vehicle traveling state.

First, similarly to the example of FIG. 2, it is determined whether temperatures TB1 and TB2 of the electrical power source less than or equal to Ab, and whether it is EV mode (S31, S32). Then, if the determination in steps S31 and S32 is YES, it is determined whether or not cruise control is being carried out (S33). If this determination is NO, processing is terminated, while if the determination is YES, a SOC target value of the capacitor CB, which is one electrical power source of the two dc electrical power sources, is set to SOC1 (for example, about 43%) (S34). Here, temperature Ab is higher than temperature Aa of the example and will be described with reference to FIG. 5. In the event that cruise control is being carried out, there is little variation in travel conditions, and it is easy for input output power of the electrical power sources to be reduced. This is why control of SOC is carried out in a higher temperature stage compared to the case of FIG. 5.

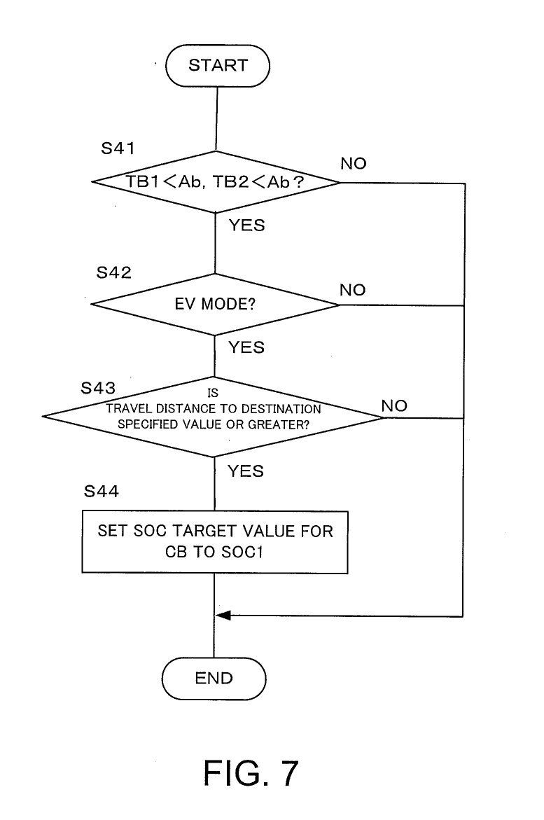

Yet another example is shown in FIG. 7. With this example, consideration is given to vehicle travel information of the vehicle (EV mode?) and travel route information. First, similarly to the example of FIG. 6, it is determined whether temperatures TB1 and TB2 of the electrical power sources are less than or equal to Ab, and whether it is EV mode (S41, S42). If the determination in steps S41 and S42 is YES, it is then determined whether a travel distance to a destination on a route that has been set in a navigation unit is a specified distance or greater (S43). If this determination is NO, processing is terminated, while if the determination is YES, a SOC target value of the capacitor CB is set to SOC1 (for example, about 43%) (S44).

It is known that the travel distance from this point on is long, and warm up of the electrical power source is carried out, as well as making both charge permissible power and discharge permissible power large.

### At the Time of Low Temperature and High Power Consumption

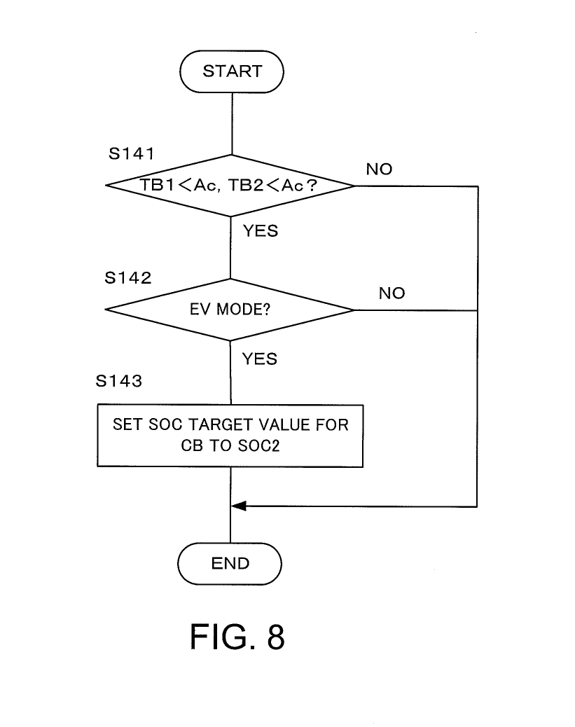

FIG. 8 is a flowchart for control at the time of low temperature, when power consumption from this point onwards is high. Specifically, consideration is given to the travel mode (is it EV mode?) as a travel state for the vehicle, at the time of low temperature. First, it is determined whether or not electrical power source temperatures TB1 and TB2 are less than or equal to Ac (S141). If the determination in S141 is NO, processing terminates at that point, while in the event that determination in S141 is YES, it is determined whether or not it is EV mode (S142).

If this determination in step S142 is NO, processing is terminated, while if the determination is YES, a SOC target value of the capacitor CB is set to SOC2 (S143).

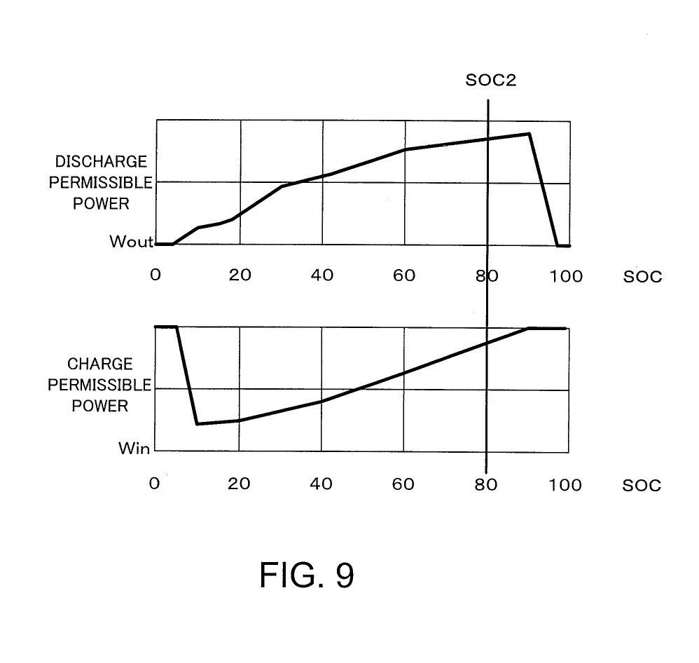

A relationship between SOC, discharge permissible power Wout and charge permissible power Win for an electrical power source is shown in FIG. 9. As can be seen, SOC 2 is a value where discharge permissible power is maximum and charge permissible power is minimum, and is, for example, about 80% with the capacitor CB of this embodiment. The value of SOC2 varies depending on the capacity or type etc. of the capacitor CB, but may be a value of 70%-8%.

By making SOC of the electrical power source (capacitor CB) SOC2 that gives a maximum condition for Wout in this way, it is possible to sufficiently perform charging for travel using this electrical power source, and EV travel can be carried out.

Normally, SOC of the capacitor CB will be lower than SOC2, and SOC of the capacitor CB may be brought up to SOC2 by conveying electrical power of the battery B1 to the capacitor CB.

In this way, by carrying out exchange of power between two electrical power sources, the amount of power going into and coming out of each electrical power source is increased, and it is possible to facilitate warming up of the two electrical power sources. It is then made possible to travel in EV mode by giving sufficient discharge permissible power for the capacitor CB.

It is also possible to increase SOC of the capacitor CB by making input power distribution ratio high and making the output power distribution ratio low for the capacitor CB, and also making the input power distribution ratio low and making the output power distribution ratio high for the battery B1, i.e. making input power large and making output power small for the capacitor CB.

### Other Examples

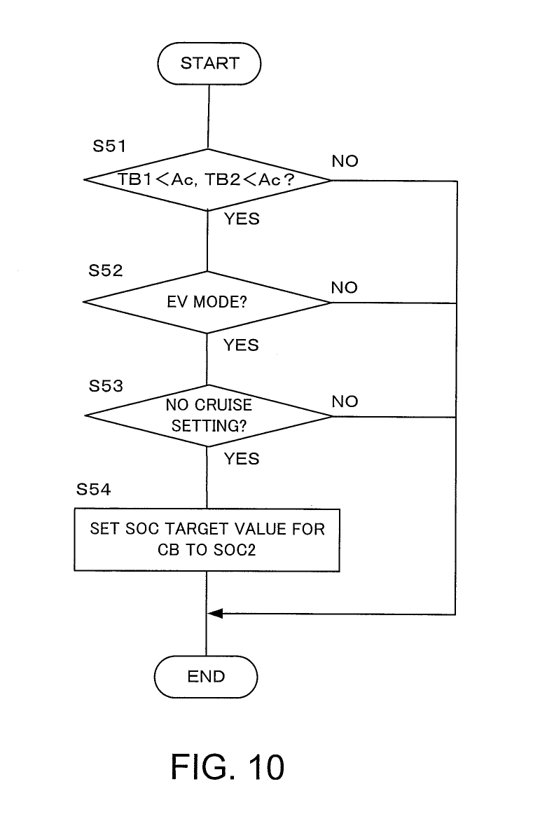

FIG. 10 shows another example. With this example, consideration is given to travel mode (is it EV mode?) as a travel state of the vehicle, and also to whether or not cruise control is off. Similarly to FIG. 8, it is determined whether the temperatures TB1 and TB2 of the electrical power sources are less than or equal to Ac, and if it is EV mode (S51, S52), and if both determinations are YES it is determined whether or not there has been cruise control setting (S53). In the event that determination in S53 is YES, SOC target value of the capacitor CB1 is then set to SOC2 (for example, about 80%) (S54).

If there is no cruise control setting, comparatively heavy power consumption in EV mode is expected, and by making SOC of the capacitor CB SOC2 that gives a maximum state of Wout, it is possible to carry out sufficient charge for traveling using this electrical power source, and EV travel can be carried out.

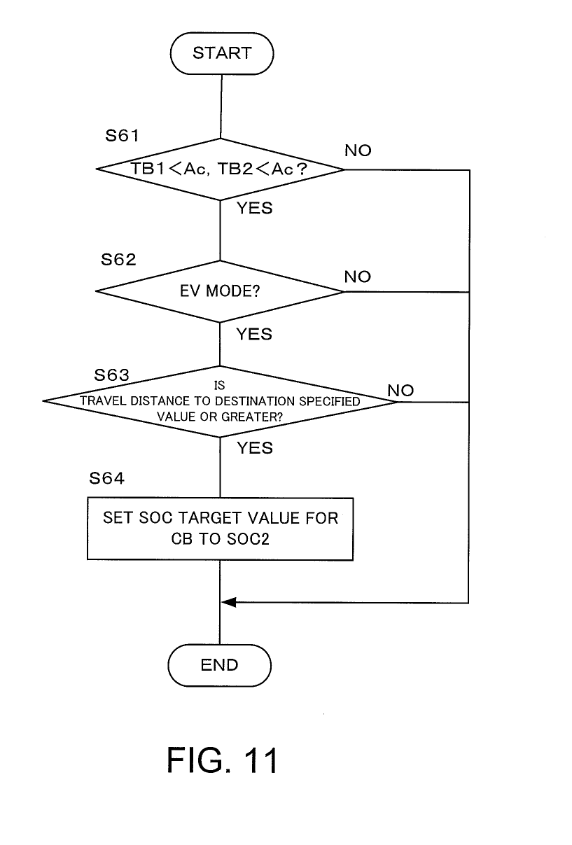

FIG. 11 shows yet another example. With this example, consideration is given to whether or not it is the EV mode as the travel state of the vehicle, and to travel route information. Similarly to FIG. 10, it is determined whether temperatures TB1 and TB2 of the electrical power sources are less than or equal to Ac, and whether it is EV mode (S61, S62), and in the event that both of these determinations are YES it is determined whether there is no cruise control setting, and whether a travel distance to a destination that has been set in a navigation unit is less than or equal to a specified value (S63). In the event that determination in S63 is YES, SOC target value of the capacitor CB is then set to SOC2 (for example, about 80%) (S64).

If travel distance to the destination is less than or equal to the specified value, it is possible to ensure travel with sufficient power in the EV mode. It is then possible to carry out EV travel that carries out sufficient discharging using the capacitor CB, by making SOC of the capacitor CB so as to give a state of maximum Wout.

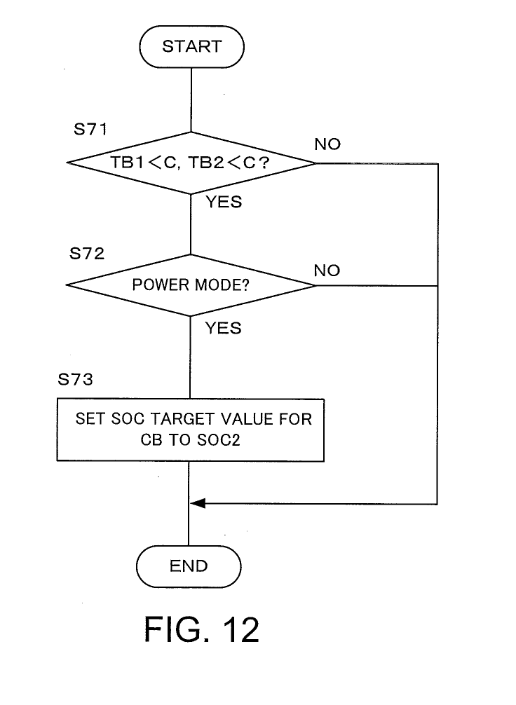

FIG. 12 shows a still further example. With this example, consideration is given to whether it is low temperature, and whether travel mode, as a vehicle travel state, is power mode. First, it is determined whether electrical power source temperatures TB1 and TB2 are less than or equal to C (S71). Here, C is about 0° C., for example, which is a low temperature but higher than Aa−Ac. Determination may be YES in a case where only one of the temperatures TB1 and TB2 of the two electrical power sources are less than or equal to C, or may be YES when both temperatures are less than or equal to C.

If the determination of S71 is YES, it is determined whether the travel mode is power mode (S72). In the event that determination in S72 is NO, processing is completed, while if the determination is YES, SOC target value of the capacitor CB is then set to SOC2 (for example, about 80%) (S73).

Since the travel mode is power mode, there is a need to make discharge permissible power Wout large as quickly as possible. Since discharge permissible power Wout is not sufficient at low temperature, SOC is made high.

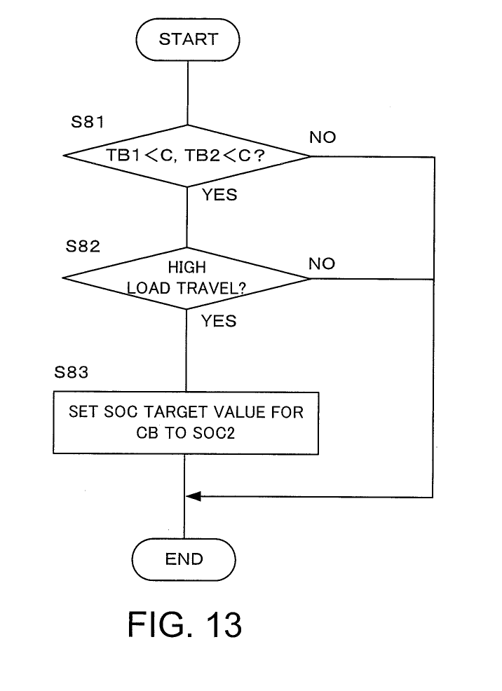

FIG. 13 shows a still further example. With this example, as well as giving consideration to whether it is low temperature, whether or not there will be high load travel, from travel route information, is also considered. It is determined whether temperatures TB1 and TB2 of the electrical power source are less than or equal to C (S81), and if the determination of this step S81 is YES then it is determined, using route information to a navigation destination, whether the travel mode will involve high load drive (S82). In the event that determination in S82 is NO, processing is completed, while if the determination is YES, SOC target value of the capacitor CB is then set to SOC2 (for example, about 80%) (S83).

From this point onwards, heavy load can be expected during travel, and it is necessary to make discharge permissible power Wout large as quickly as possible. Since discharge permissible power Wout is not sufficient at low temperature, SOC is made high.

Prediction of high load will result in cases such as where there is a large difference in altitude between the destination on the current position.

### At the Time of Low Temperature and Low Power Consumption

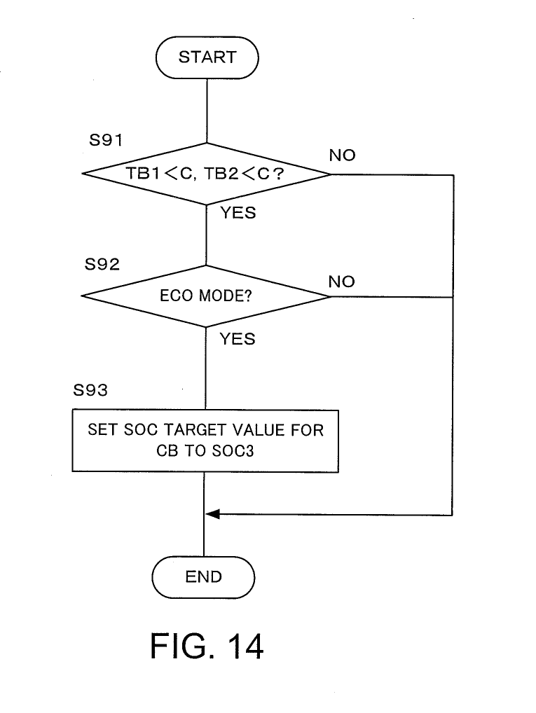

FIG. 14 is a flowchart for control at the time of low temperature, when power consumption from this point onwards is low. With this example, determination is given to whether it is low temperature, and whether travel mode, as travel state information, is eco-mode. First, it is determined whether electrical power source temperatures TB1 and TB2 are less than or equal to C (S91). If the determination in S91 is NO, processing terminates at that point, while in the event that determination in S91 is YES, it is determined whether or not it is eco-mode (S92).

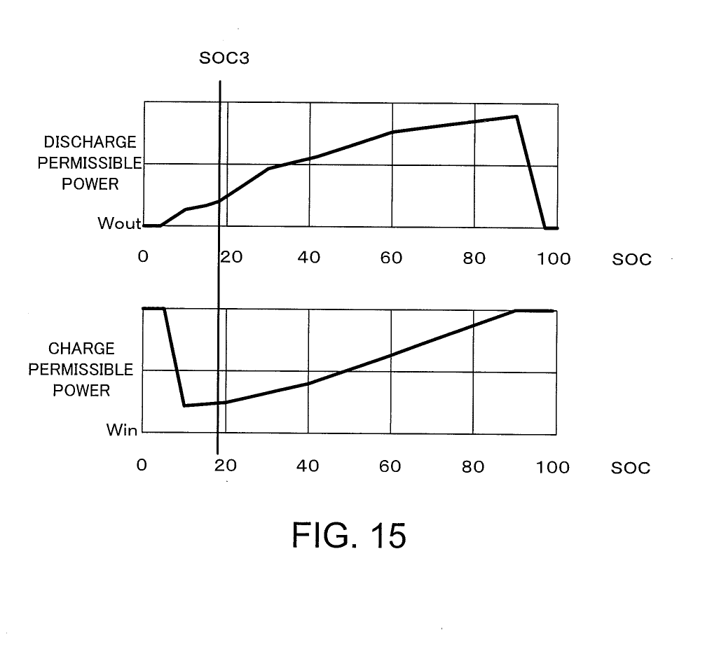

If this determination in step S92 is NO, processing is terminated, while if the determination is YES, a SOC target value of the capacitor CB is set to SOC3 (S93). A relationship between SOC, discharge permissible power Wout and charge permissible power Win for an electrical power source is shown in FIG. 15. As can be seen, SOC 3 is a value where charge permissible power is maximum and discharge permissible power is minimum, and is, for example, about 18% with the capacitor CB of this embodiment. The value of SOC3 varies depending on capacity and type etc. of the capacitor CB, but may be a value of 10%-30%.

In this way, by making SOC of the capacitor CB such that Win is a maximum state, it is possible to sufficiently carry out charging for travel using this electrical power source, and EV travel can be carried out using regenerative braking. Normally, SOC of the capacitor CB will be higher than SOC3, and SOC of the capacitor CB may be lowered to SOC3 by conveying electrical power of the capacitor CB to the battery B1.

In this way, by carrying out exchange of power between two electrical power sources, the amount of power going into and coming out of each electrical power source is increased, and it is possible to facilitate warming up of the two electrical power sources. In the case of eco-mode, there is a need to completely exchange electrical power resulting from regenerative braking. It is then made possible to travel in EV mode where regenerative braking is sufficiently carries out by giving sufficient charge permissible power for the capacitor CB.

It is also possible to make output power distribution ratio of the capacitor CB high and make the input power distribution ratio low, and also to make the output power distribution ratio of the battery B1 low and make the input power distribution ratio high, to make output power of the capacitor CB large, and to also make input power of the capacitor CB small so as to reduce SOC of the capacitor CB.

### Other Examples

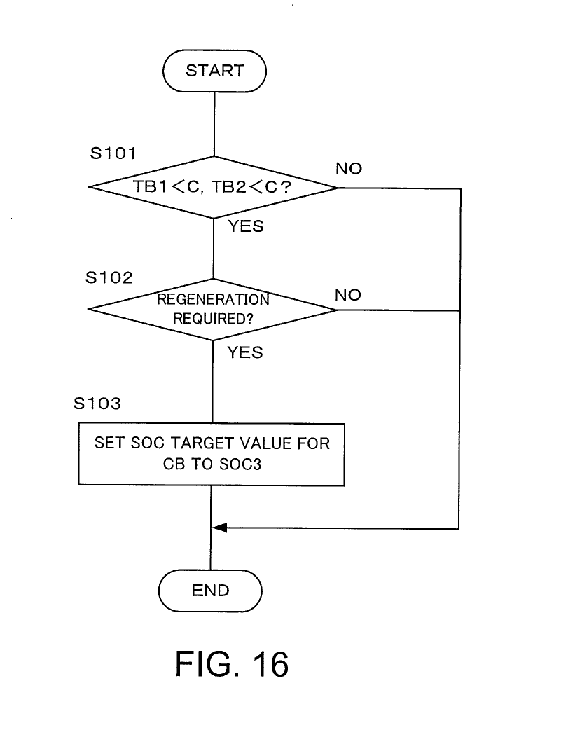

FIG. 16 shows another example. With this example, consideration is given to whether it is low temperature, and whether there is a need for generation based on vehicle route information. Similarly to FIG. 14, it is determined whether temperatures TB1 and TB2 of the electrical power sources are less than or equal to C (S101), and if the result of this determination is YES it is then determined, from navigation information, whether or not regenerative braking can be expected from that point forward (S102). In the event that determination in S102 is YES, SOC target value of the capacitor CB is then set to SOC3 (S103).

In the event that regenerative braking is expected, it is desirable to sufficiently exchange regenerated power. EV travel to sufficiently exchange regenerated power with the capacitor CB can therefore be carried out by making SOC of the capacitor CB such that Win is a maximum state.

### Considerations for Power Consumption Characteristics

As has been described above, with this embodiment, consumption state of power for travel is estimated in accordance with navigation information, cruise setting, power/eco-mode setting, etc. As a result it is possible to estimate SOC variation for an electrical power source in travel, and appropriate target SOC setting becomes possible.

### Other Example of System Structure

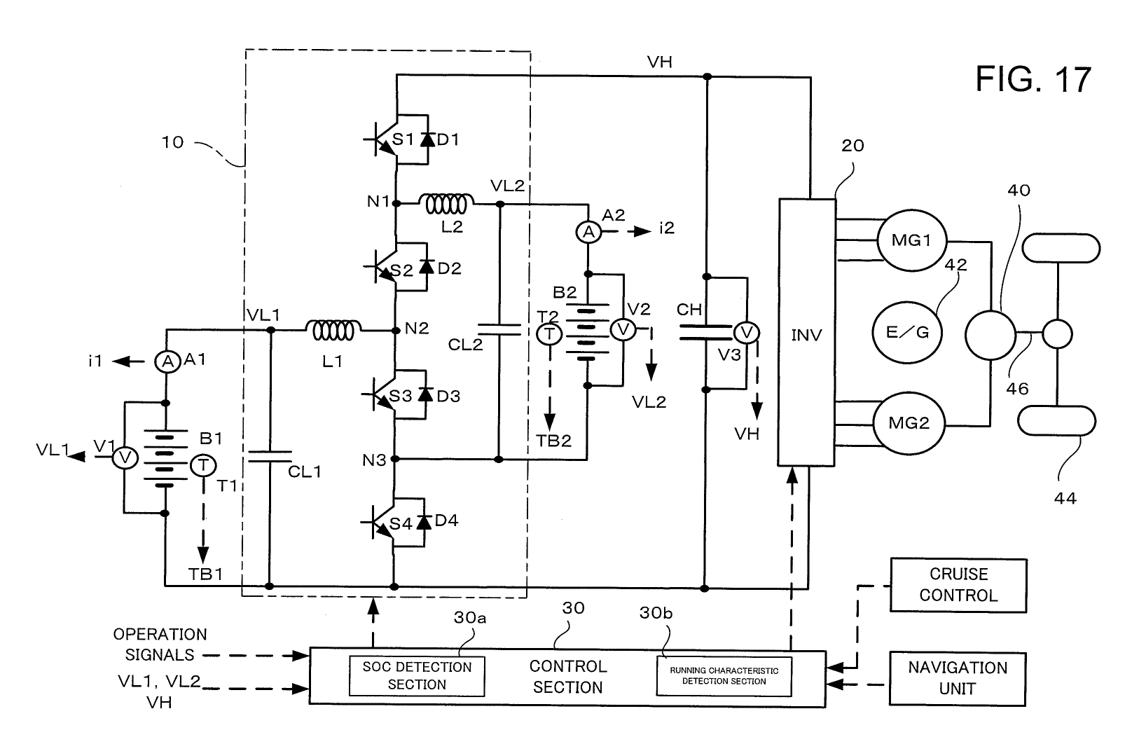

Another example of system structure is shown in FIG. 17. With this example, as the converter 10, four switching elements S1-S4 are connected in series between a positive line and a negative line. Two batteries B1 and B2 are then connected to this converter 10. The converter 10 boosts DC voltages VL1 and VL2 from the batteries B1 and B2 to a high voltage side voltage VH, and supplies this voltage VH to the positive line and negative line at the input side of an inverter 20. Besides the structure of the converter 10 and the batteries B1 and B2, this example is the same as that shown in FIG. 1.

Of the switching elements S1-S4 of the converter 10, the collector of the uppermost switching element S1 is connected to a positive output terminal of a high-voltage side of the converter 10 and connected to a positive line of a high voltage side. The collector of switching element S2 is connected to the emitter of switching element S1, the collector of switching element S3 is connected to the emitter of switching element S2, the collector of switching element S4 is connected to the emitter of switching elements S3, and the emitter of switching element S3 is connected to the negative line. The negative line is connected to earth.

Also, diodes D1 to D4 in which current flows in a direction from emitter to collector are respectively connected in parallel with each switching element S1 to S4, and current of an inverse direction flows in the switching elements S1 to S4.

The converter 10 has a reactor L1 and a condenser CL1. A positive electrode of the battery B1 is connected via the reactor L1 to node N2. A negative electrode of the battery B1 is connected to the negative line. Also, the condenser CL1 is connected between the negative electrode of the battery B1 and a point of connection between the positive electrode of the battery and the reactor L1.

The converter 10 also has a reactor L2 and a condenser CL2. The condenser CL2 is connected to the positive electrode and negative electrode of the battery B2, the condenser CL2 and the positive electrode side of the battery B2 are connected via reactor L2 to node N1, and the condenser CL2 and the negative electrode side of the battery B2 are connected to node N3.

In this circuit of FIG. 17, by controlling on and off states of the switching elements S1-S4 of the converter 10, a low-tension side of the converter 10 can be put into a series connection mode where the batteries B1 and B2 are connected in series or a parallel connection mode where the two batteries B1 and B2 are connected in parallel. It is also possible to use the batteries B1 and B2 independently as a low-tension side battery. Specifically, if switching elements S1 and S2 are made one group, and switching elements S3 and S4 are made another group, they will function as a converter for battery B1, while if switching elements S1 and S4 are made one group and switching elements S2 and S3 are made another group, they will function as a converter for battery B2. In the case where only one of the batteries B1 and B2 is used, the other of the batteries B2 and B1 that is not used is preferably isolated from the circuit, as required. It is also preferable to use battery B1 in the case of setting a high SOC, to use battery B1 in the case of setting low SOC, and to set to the parallel connection mode or the series connection mode when setting an intermediate SOC.

With this type of system also, since there are two batteries B1 and B2, it is possible to independently control SOC of the batteries B1 and B2, and it is possible to either transfer power between each battery B1 and B2, or to set a desired SOC by adjusting input output power distribution ratio of each of the batteries B1 and B2 by making connection between the battery B1 and the battery B2 the parallel connection mode.

What is claimed is:

1. A control device for a hybrid vehicle, comprising:
an engine;
a motor;
a plurality of electrical power sources for supplying electrical power to the motor; and
a control section for controlling SOC of one electrical power source, among the plurality of electrical power sources, to be a specified value, based on temperature of the one electrical power source, and at least either travel state of the vehicle or travel route information.

2. The control device for a hybrid vehicle of claim 1, further comprising:
an electrical power converter for conveying electrical power between the plurality of electrical power sources, and wherein
the control section
controls SOC of the one electrical power source by controlling the electrical power converter to convey electrical power between the one electrical power source and other electrical power sources.

3. The control device for a hybrid vehicle of claim 2, wherein:
the control section
when the one electrical power source is in a low temperature state, controls SOC of the one electrical power source so that a difference between size of permissible discharge amount and size of permissible charge amount of the one electrical power source becomes minimum.

4. The control device for a hybrid vehicle of claim 2, wherein:
the control section
when the one electrical power source is in a low temperature state,
controls SOC of the one electrical power source so that permissible discharge amount of the one electrical power source becomes maximum.

5. The control device for a hybrid vehicle of claim 2, wherein:
the control section
when the one electrical power source is in a low temperature state,
in the event that a regenerative braking state continues, controls SOC of the one electrical power source so that permissible charge amount of the one electrical power source becomes maximum.
